(19) United States
(12) Patent Application Publication
(10) Pub. No.: US 2018/0213902 A1
(43) Pub. Date: Aug. 2, 2018

(54) PROTECTIVE CASE FOR OUT-FOLDING IMAGE DISPLAY DEVICE PROVIDED WITH FLEXIBLE DISPLAY DEVICE, AND PROTECTIVE CASE APPLICATION METHOD

(71) Applicant: You Seob Lim, Goyang-si (KR)

(72) Inventor: You Seob Lim, Goyang-si (KR)

(21) Appl. No.: 15/748,195

(22) PCT Filed: Aug. 1, 2016
(86) PCT No.: PCT/KR2016/008460

§ 371 Date: Jan. 28, 2018

(30) Foreign Application Priority Data
Aug. 3, 2015 (KR) 10-2015-0109280

(51) Int. Cl. A45C 11/00; H04B 1/3888

(52) U.S. Cl. CPC A45C 11/00; A45C 2011/003; A45C 2011/002; H04B 1/3888

(57) ABSTRACT

The present invention relates to a bumper case and a protective case which are applied to an out-folding image display device, the circumferential shape of which changes by the folding or unfolding rotation of a folding axis, unlike existing plate-shaped image display devices having an unchangeable circumferential shape, and to a bumper case, a protective case, and an integrated case for an out-folding image display device, which do not restrict the folding and unfolding of a flexible display device even if the bumper case and protective case are additionally applied to the out-folding image display device.

### TECHNICAL FIELD

The present invention relates to a protective case and a bumper case of an out-folding image display device provided with a flexible display device and the out-folding image display device for application of these cases, and more specifically, in an out-folding image display device of a method of folding a center portion while display surfaces of a flexible display device are folded in a back to back position, the present invention relates to a protective case, a bumper case and an integrated case for an out-folding image display device, which do not restrict folding and unfolding of the flexible display device although the protective case or the bumper case is additionally applied, and the out-folding image display device for application of these cases.

### BACKGROUND ART

Due to generalization of shape-invariant image display devices such as existing plate-shaped smart phones and tablet devices, additional products such as a bumper case for preventing damage of a liquid crystal display screen from an impact (Korean Patent Registration No. 10-1229079), a diary type case capable of storing an image display device in an inner space of a diary type cover and having a function of storing credit cards (Korean Patent Registration No. 10-1192287, Korean Utility Model Registration No. 30-0473451), and a bumper-integrated case combining the functions of the bumper case and the diary type case (Korean Utility Model Registration No. 20-0460260) are widely used, and various patents are presented in relation thereto.

A bumper case product is fixed while wrapping the circumference of an existing shape-invariant image display device product, such as a smart phone or a tablet computer, without a discontinued portion, in which the top surface for displaying a screen is formed open from the circumference to enable touch handling and screen display, and a surface on the opposite side of the surface for displaying a screen is formed closed or open by extending the circumference.

A diary type case is configured of a bottom surface fixing plate tightly fixed or assembled to be fixed on a surface on the opposite side of the screen display surface of an existing shape-invariant image display device product such as a smart phone or a tablet computer, a rotating connection plate formed by extending an end portion of the bottom surface fixing plate or adhesively connecting an end portion to an end portion of the bottom surface fixing plate, and a top surface cover plate formed to be extended or adhesively connected to an end portion on the opposite side of the rotating connection plate to selectively cover the screen display surface, and pockets for storing credit cards are formed on the inner surface of the top surface cover plate.

A bumper-integrated case combining a bumper case and a diary type case is fixed while seamlessly wrapping the circumference of an existing shape-invariant image display device product, such as a smart phone or a tablet computer, in which the top surface for displaying a screen is formed open from the circumference, and a surface on the opposite side, which does not display a screen, is configured of a bumper bottom plate fixed on a surface on the opposite side of the screen display surface of the shape-invariant image display device, a rotating connection plate 2 formed to adhesively fix an end portion to the surface of the bumper bottom plate, and a top surface cover plate 2 connected to an end portion of the rotating connection plate 2 to selectively cover the screen display surface.

All the existing bumper case, diary type case and bumper-integrated case are plate-shaped and proposed to be applied to a shape-invariant image display device and may not be applied to an out-folding image display device in which the circumferential shape is changed as folding and unfolding of a flexible display device are performed by folding axis rotation.

### DISCLOSURE OF INVENTION

### Technical Problem

The problems to be solved by the present invention are as described below.

First, an object of the present invention is to implement a bumper case, a diary type case or a bumper-integrated case for an out-folding image display device, in which folding and unfolding of a screen display area can be freely performed around a folding axis without being interfered although the bumper case, the diary type case or the bumper-integrated case is applied to the outer line of the out-folding image display device.

Second, another object of the present invention is to selectively wrap and cover a curved-surface shape portion of a folding axis part so that the surface of a flexible display device of a curved-surface shape positioned at the folding axis part when the out-folding image display device is stored in a folded state can be protected from dents or scratches.

### Technical Solution

To accomplish the above objects, a first embodiment of the present invention may be configured to include an open-type bumper case applied to an asymmetric out-folding image display device performing asymmetric unfolding around a folding axis to remove an interference area, which is a circumferential area affecting folding and unfolding of a folding axis in the outer circumferential portion of the asymmetric out-folding image display device, and it is fixed or assembled while wrapping a circumferential portion of an invariant area maintaining a constant shape and position at all times without being affected by folding and unfolding of the folding axis.

In the open-type bumper case of the first embodiment, to fix the asymmetric out-folding image display device, a corner latching step is formed at a portion contacting with a surface positioning on the opposite side of the folding axis of the asymmetric out-folding image display device and at portions contacting with a top circumference and a bottom circumference perpendicular to the folding axis of the asymmetric out-folding image display device, and a folding axis part latching step partially wrapping other portions excluding the interference removal area included in a portion positioning at the folding axis of the asymmetric out-folding image display device is formed.

In a second embodiment, which is another embodiment of the present invention, there is provided a fixing-support-plate applied case including: a top open cover for selectively covering an fixed screen display part of an asymmetric out-folding image display device in a rotatable state and corresponding to a top surface fixing plate, a bottom open cover for selectively covering a foldable and securable display of the asymmetric out-folding image display device in a rotatable state and corresponding to a bottom surface fixing plate, a connection cover for connecting the top open cover and the bottom open cover and corresponding to a rotating connection plate of a diary type case, and a fixing support plate, in which an end portion is adhered or fixed to a surface positioning on the opposite side of the fixed screen display part of the asymmetric out-folding image display device, and the other unadhered or unfixed portions on the opposite side are adhered or fixed to a portion of the connection cover or the connection cover and the top open cover.

In the second embodiment, a folding axis cover for covering the outer periphery of the asymmetric out-folding image display device may be applied at a folding axis side end portion of the top open cover or the bottom cover of the fixing-support-plate applied case, and in a third embodiment, the folding axis cover is applied unlike the second embodiment to which the folding axis cover is not applied.

In addition, regardless of applying the fixing-support-plate applied case to an asymmetric out-folding image display device, the fixing-support-plate applied case is applied to a symmetric out-folding image display device in fourth and fifth embodiments, in which a folding axis cover is not applied in the fourth embodiment, and a folding axis cover is applied in the fifth embodiment.

In a sixth embodiment, which is another embodiment of the present invention, there is provided a connection cover fixing case including: a top open cover for selectively covering an fixed screen display part of an asymmetric out-folding image display device in a rotatable state and corresponding to a top surface fixing plate, a bottom open cover for selectively covering a foldable and securable display of the asymmetric out-folding image display device in a rotatable state and corresponding to a bottom surface fixing plate, a connection cover for connecting the top open cover and the bottom open cover, having one or more penetration holes penetratingly formed to be fixed to one or more protective case fixing holes formed on a surface on the opposite side of the folding axis of the asymmetric out-folding image display device and corresponding to a rotating connection plate of a diary type case, and a load distribution plate fixed to the protective case fixing holes of the asymmetric out-folding image display device using a fixing means including a fixing screw to press the connection cover to be fixed on a surface on the opposite side of the folding axis of the asymmetric out-folding image display device.

In the sixth embodiment, a folding axis cover for covering the outer periphery of the asymmetric out-folding image display device may be applied at a folding axis side end portion of the top open cover or the bottom cover of the connection cover fixing case, and the folding axis cover is applied in a seventh embodiment unlike the sixth embodiment to which the folding axis cover is not applied.

In addition, regardless of applying the connection cover fixing case to an asymmetric out-folding image display device, the connection cover fixing case is applied to a symmetric out-folding image display device in eighth and ninth embodiments, in which a folding axis cover is not applied in the eighth embodiment, and a folding axis cover is applied in the ninth embodiment.

In a tenth embodiment, which is another embodiment of the present invention, there is provided an open-type bumper-integrated case including: a top open cover for selectively covering an fixed screen display part of an asymmetric out-folding image display device in a rotatable state and corresponding to a top surface fixing plate, a bottom open cover for selectively covering a foldable and securable display of an asymmetric out-folding image display device in a rotatable state and corresponding to a bottom surface fixing plate, an open-type bumper applied to be latched to the shape-invariant circumference of the asymmetric out-folding image display device and formed open by removing an interference removal area part, which is an area included in the outer circumferential portion of the asymmetric out-folding image display device, where interference occurs when a folding axis is folded or unfolded, in which one surfaces of the fixed screen display part and the foldable and securable display side have an open shape, and a connection cover for connecting the top open cover and the bottom open cover, in which a corresponding portion is adhesively or connectedly fixed to a connection cover recess fixing unit formed on a surface positioning on the opposite side of the folding axis of the asymmetric out-folding image display device among the one surfaces of the open-type bumper.

In the tenth embodiment, a folding axis cover for covering the outer periphery of the asymmetric out-folding image display device may be applied at a folding axis side end portion of the top open cover or the bottom cover of the open-type bumper-integrated case, and the folding axis cover is applied in an eleventh embodiment unlike the tenth embodiment to which the folding axis cover is not applied.

In a twelfth embodiment, which is another embodiment of the present invention, there is provided a bottom cover partitioning case including: a top open cover for selectively covering an fixed screen display part of an asymmetric out-folding image display device in a rotatable state and corresponding to a top surface fixing plate, a bottom partition fixing cover fixed to the asymmetric out-folding image display device in a state incapable of rotating as the portions on one surface positioned when a foldable and securable display of the asymmetric out-folding image display device is in a folded state, excluding an interference removal area part related to rotation of the foldable and securable display, are latched and fixed to a plurality of fixing bands and corresponding to the bottom surface fixing plate, a bottom rotating cover separated while an end portion is connected to the bottom partition fixing cover in a rotatable state at a portion positioning in the interference removal area of the bottom partition fixing cover in a selectively rotatable state, or fixed in a rotatable state by the separately applied connection cover, and the connection cover for connecting the top open cover and the bottom partition fixing cover and corresponding to the rotating connection plate of the diary type case.

In the twelfth embodiment, a folding axis cover for covering the outer periphery of the asymmetric out-folding image display device may be applied at a folding axis side end portion of the top open cover or the bottom cover of the bottom cover partitioning case, and the folding axis cover is applied in a thirteenth embodiment unlike the twelfth embodiment to which the folding axis cover is not applied.

### Advantageous Effects

As described above, according to the embodiments of the present invention, although a bumper case, a protective case of a diary form or an integrated protective case combining the bumper case and the protective case of a diary form is applied to the outer circumference of an out-folding image display device, folding and unfolding of a screen display area can be selectively performed around a folding axis without being restricted.

Furthermore, since an end portion of the folding axis of a protective case cover of a diary type has a folding axis cover shape capable of wrapping and covering a flexible display device portion of a curved-surface shape positioned at the folding axis part when the out-folding image display device is stored in a folded state, the surface of the flexible display device of a curved-surface shape positioned at the folding axis part may be protected from dents or scratches.

### BRIEF DESCRIPTION OF THE DRAWINGS

FIG. 1 is an exemplary view and an assembly view showing a circular bumper case applied to a shape-invariant image display device without a folding function.

FIG. 2 is an exemplary view and an assembly view showing a diary type case applied to a shape-invariant image display device without a folding function.

FIG. 3 is an exemplary view and an assembly view showing a bumper-integrated case applied to a shape-invariant image display device without a folding function.

FIG. 4 is plan views and front views showing folded and unfolded states of an asymmetric out-folding image display device.

FIG. 5 is plan views and front views showing folded and unfolded states of a symmetric out-folding image display device.

FIG. 6 is a plan view, a front view and a rear view showing an open-type bumper case applied to an asymmetric out-folding image display device of a folded state.

FIG. 7 is cross-sectional views of the portions shown in FIG. 6.

FIG. 8 is a conceptual view of fixing an open-type bumper case to an asymmetric out-folding image display device.

FIG. 9 is a plan view and a front view showing a fixing-support-plate applied case applied to an asymmetric out-folding image display device.

FIG. 10 is a plan view and a front view showing a fixing-support-plate applied case provided with a folding axis cover and applied to an asymmetric out-folding image display device.

FIG. 11 is a conceptual view of fixing a fixing-support-plate applied case to an asymmetric out-folding image display device.

FIG. 12 is a perspective view and a front view showing a fixing-support-plate applied case applied to an asymmetric out-folding image display device and a folding and unfolding transition state.

FIG. 13 is a perspective view and a front view showing a state of maintaining a completely spread state of a top open cover and a closed state of a bottom open cover while an asymmetric out-folding image display device applied with a fixing-support-plate applied case is in a completely spread state.

FIG. 14 is a plan view and a front view showing a fixing-support-plate applied case applied to a symmetric out-folding image display device.

FIG. 15 is a plan view and a front view showing a fixing-support-plate applied case provided with a folding axis cover and applied to a symmetric out-folding image display device.

FIG. 16 is a conceptual view of fixing a fixing-support-plate applied case to a symmetric out-folding image display device.

FIG. 17 is a perspective view and a front view showing a fixing-support-plate applied case applied to a symmetric out-folding image display device and a folding and unfolding transition state.

FIG. 18 is a perspective view and a front view showing a state of maintaining a completely spread state of a top open cover and a closed state of a bottom open cover while a symmetric out-folding image display device applied with a fixing-support-plate applied case is in a completely spread state.

FIG. 19 is a plan view, a front view and a cross-sectional view showing a connection cover fixing case applied to an asymmetric out-folding image display device.

FIG. 20 is a plan view and a front view showing a connection cover fixing case provided with a folding axis cover and applied to an asymmetric out-folding image display device.

FIG. 21 is a conceptual view of fixing a connection cover fixing case to an asymmetric out-folding image display device.

FIG. 22 is a perspective view and a front view showing a folding and unfolding transition state of an asymmetric out-folding image display device applied with a connection cover fixing case.

FIG. 23 is a perspective view and a front view showing a state of maintaining a completely spread state of a top open cover and a closed state of a bottom open cover while an asymmetric out-folding image display device applied with a connection cover fixing case is in a completely spread state.

FIG. 24 is a perspective view and a conceptual view showing a connection cover fixing case applied and fixed to a symmetric out-folding image display device.

FIG. 25 is a perspective view and a conceptual view showing a connection cover fixing case provided with a folding axis cover and applied and fixed to a symmetric out-folding image display device.

FIG. 26 is a plan view, a front view and a cross-sectional view showing an open-type bumper-integrated case applied to an asymmetric out-folding image display device.

FIG. 27 is a plan view, a front view and a cross-sectional view showing an open-type bumper-integrated case provided with a folding axis cover and applied to an asymmetric out-folding image display device.

FIG. 28 is a conceptual view of fixing an open-type bumper-integrated case to an asymmetric out-folding image display device.

FIG. 29 is a perspective view and an exploded perspective view showing an open-type bumper-integrated case.

FIG. 30 is a perspective view and a front view showing a folding and unfolding transition state of an asymmetric out-folding image display device applied with an open-type bumper-integrated case.

FIG. 31 is a perspective view and a front view showing a state of maintaining a completely spread state of a top open cover and a closed state of a bottom open cover while an asymmetric out-folding image display device applied with an open-type bumper-integrated case is in a completely spread state.

FIG. 32 is a plan view and a front view showing a bottom cover partitioning case applied to an asymmetric out-folding image display device.

FIG. 33 is a perspective view and a conceptual view showing a bottom cover partitioning case applied and fixed to an asymmetric out-folding image display device.

FIG. 34 is perspective views showing a bottom cover partitioning case not applied with a folding axis cover and a bottom cover partitioning case applied with a folding axis cover, which are applied to an asymmetric out-folding image display device.

### DESCRIPTION OF SYMBOLS

Symbols of major portions of the accompanying drawings are described as shown below.

10: shape-invariant image display device

11: circular bumper case

12: diary type case

13: top surface cover plate

14: rotating connection plate

15: bottom surface fixing plate

16: bumper-integrated case

17: bumper bottom plate

20: asymmetric out-folding image display device

21: symmetric out-folding image display device

22: fixed screen display part

23: foldable and securable display

24: protective case fixing hole

30: open-type bumper case

31: interference removal area

32: corner latching step

33: folding axis part latching step

40: fixing-support-plate applied case

41: connection cover fixing case

42: open-type bumper-integrated case

43: bottom cover partitioning case

50: top open cover

51: folding axis cover

52: connection cover

53: bottom open cover

54: fixing support plate

55: fixing hole

56: load distribution plate

57: fixing screw

70: open-type bumper

71: connection cover recess fixing unit

80: bottom partition fixing cover

81: bottom rotating cover

82: fixing band

### BEST MODE FOR CARRYING OUT THE INVENTION

Hereafter, the preferred embodiments of the present invention will be described in detail with reference to the accompanying drawings. The terms used in the specification are used to just describe the embodiments and do not intend to limit the present invention. In the specification, singular forms include plural forms unless the context clearly indicates otherwise. Furthermore, reference symbols presented in the order of the description is not necessarily limited to the specified order.

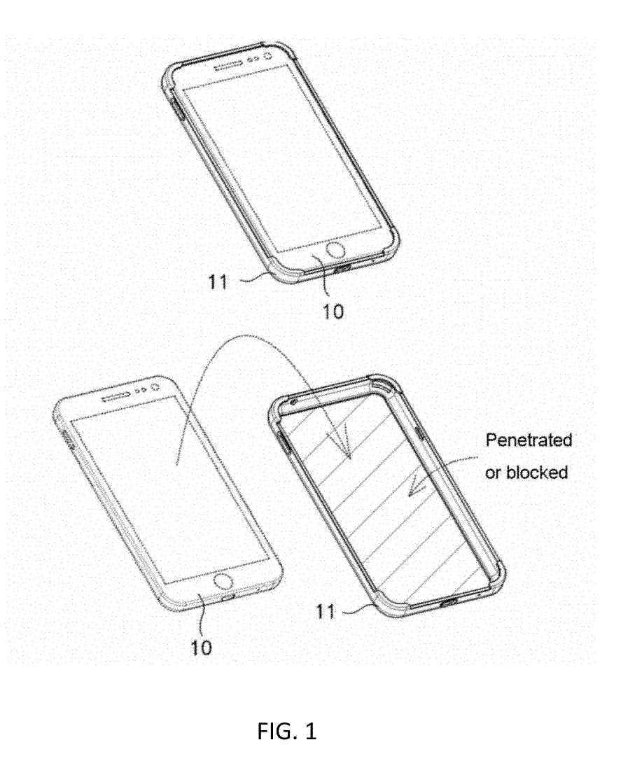

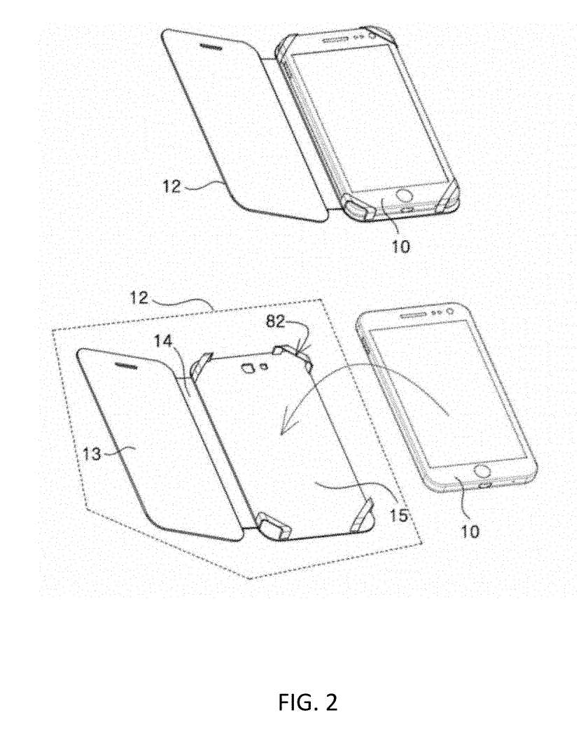

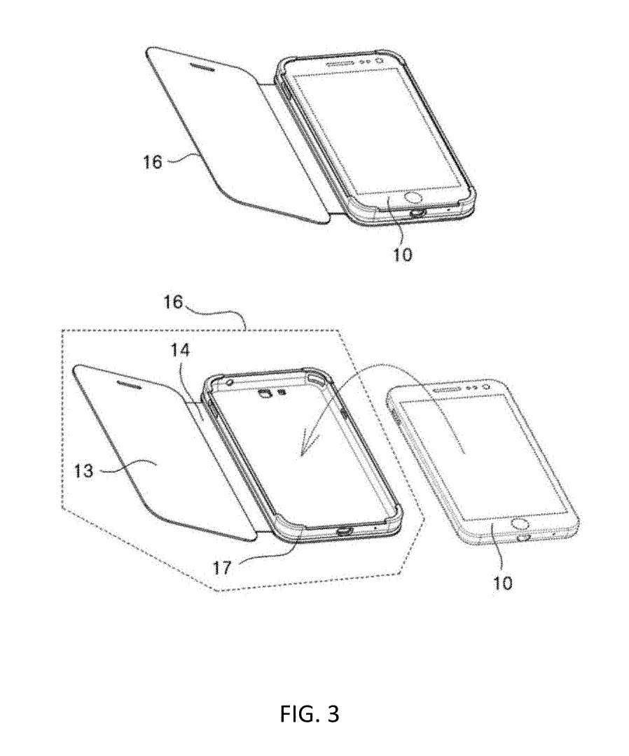

FIG. 1 is an exemplary view and an assembly view showing a circular bumper case applied to a shape-invariant image display device without a folding function, FIG. 2 is an exemplary view and an assembly view showing a diary type case applied to a shape-invariant image display device without a folding function, and FIG. 3 is an exemplary view and an assembly view showing a bumper-integrated case applied to a shape-invariant image display device without a folding function.

As shown in FIGS. 1, 2 and 3, additional products such as a circular bumper case 11 (Korean Patent Registration No. 10-1229079), a diary type case 12 (Korean Patent Registration No. 10-1192287, Korean Utility Model Registration No. 30-0473451) and a bumper-integrated case 16 (Korean Utility Model Registration No. 20-0460260) are widely used in a shape-invariant image display device 10 such as existing plate-shaped smart phones and tablet computers to add a protection or storage function of the shape-invariant image display device 10.

As shown in FIG. 1, a circular bumper case 11 is fixed while wrapping the entire outer circumference of a shape-invariant image display device 10 in the form of circulating the entire circumference without a discontinued portion, and a screen display part is open for easy touch handling and confirmation of screen information.

Since a method of fixing the circular bumper case 11 while wrapping the outer circumference of the shape-invariant image display device 10 in the form of circulating the entire circumference without a discontinued portion is applied, there is a problem in that the circular bumper case 11 cannot be applied to an out-folding image display device, in which the circumferential shape of the image display device is changed as a freely bent flexible display device performs folding axis folding and unfolding.

As shown in FIG. 2, a diary type case 12 is configured to include a top surface cover plate 13 rotated by a user to selectively cover a screen display surface of a shape-invariant image display device 10, a rotating connection plate 14 formed by extending an end portion of a rotating axis of the top surface cover plate 13 or adhesively or connectedly fixed to the end portion of the rotating axis of the top surface cover plate 13 using a material easy to unfold and fold without regard to the top surface cover plate 13, and a bottom surface fixing plate 15 incapable of rotating as it is formed by extending an end portion of the rotating connection plate 14 or adhesively connected to an end portion of the rotating connection plate 14, and adhesively fixed on a surface on the opposite side of the screen display surface of the shape-invariant image display device 10 or latched and fixed to the corners by latching bands.

The shape-invariant image display device 10 is fixed to the bottom surface fixing plate 15 in an adhesion method, a latching method using fixing bands, or a screw fixing method of the bottom surface fixing plate 15 using fixing screws on a surface on the opposite side of the screen display surface of the shape-invariant image display device 10.

As shown in FIG. 3, a bumper-integrated case 16 is configured to include a top surface cover plate 13 rotated by a user to selectively cover a screen display surface of a shape-invariant image display device 10, a rotating connection plate 14 formed by extending an end portion of a rotating axis of the top surface cover plate 13 or adhesively connected to the end portion of the rotating axis of the top surface cover plate 13 using a material easy to unfold and fold without regard to the top surface cover plate 13, and a bumper bottom plate 17 incapable of rotating as it is fixed while wrapping the outer circumference of the shape-invariant image display device 10 in the form of circulating the entire circumference without a discontinued portion, and adhesively connected to the rotating connection plate 14 in a state of blocking a surface on the opposite side of the screen display surface although the screen display part is open.

As shown in FIGS. 2 and 3, since the bottom surface fixing plate 15 and the bumper bottom plate 17 are fixed on a surface on the opposite side of the screen display surface of the image display device and configure a structure incapable of opening rotation like the top surface cover plate 13, there is a structural problem in that if the diary type case 12 or the bumper-integrated case 16 is applied to an out-folding image display device, a foldable and securable display 23 folded and stored inside the bottom surface fixing plate 15 and the bumper bottom plate 17 is constrained in a folded state and cannot be unfolded when the out-folding image display device is folding axis-unfolded, due to the bottom surface fixing plate 15 or the bumper bottom plate 17 that cannot perform opening rotation.

Accordingly, unlike the shape-invariant image display device 10, it is understood that the circular bumper case 11, the diary type case 12 and the bumper-integrated case 16 as shown in FIGS. 1, 2 and 3 cannot be applied to an out-folding image display device, the circumferential shape of which is changed when folding axis folding and unfolding of a flexible display device is performed, and a separate case is required for the out-folding image display device.

The present invention presents a case of an out-folding image display device and requirements for the shape of the out-folding image display device for applying the case and describes them in detail through various embodiments according to classification of out-folding image display device types.

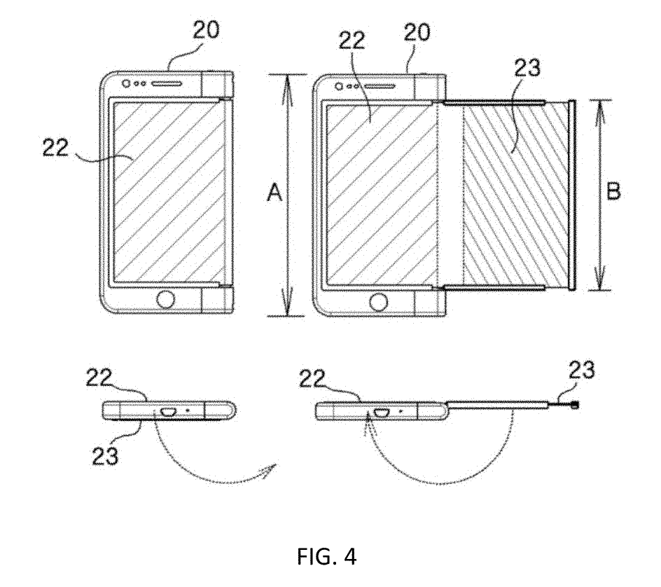

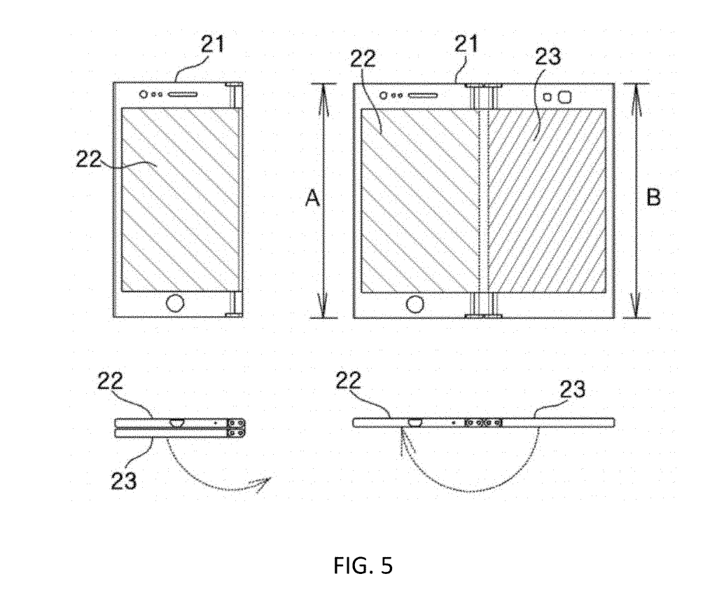

FIG. 4 is plan views and front views showing folded and unfolded states of an asymmetric out-folding image display device, and FIG. 5 is plan views and front views showing folded and unfolded states of a symmetric out-folding image display device.

As shown in FIGS. 4 and 5, the overall vertical length B of the unfolded portion including a screen display part unfolded when unfold rotation is performed around the folding axis may or may not accord with the overall vertical length A of the portion including the fixed screen display part, and the embodiments of the present invention will be described by arbitrarily classifying the out-folding image display device as an asymmetric out-folding image display device 20 if A and B does not accord with each other as shown in FIG. 4 and classifying the out-folding image display device as a symmetric out-folding image display device 21 if A and B accord with each other as shown in FIG. 5.

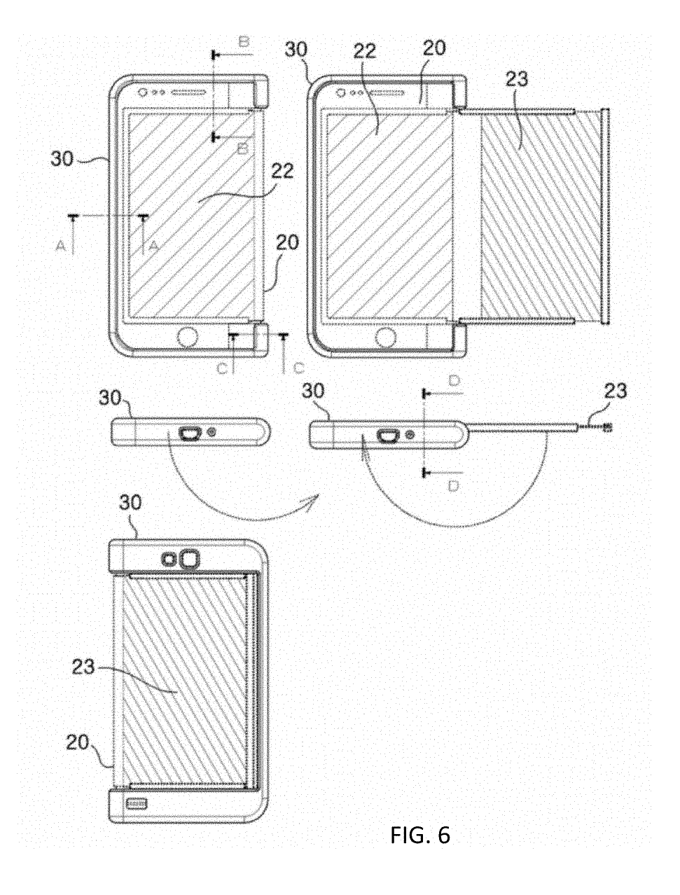

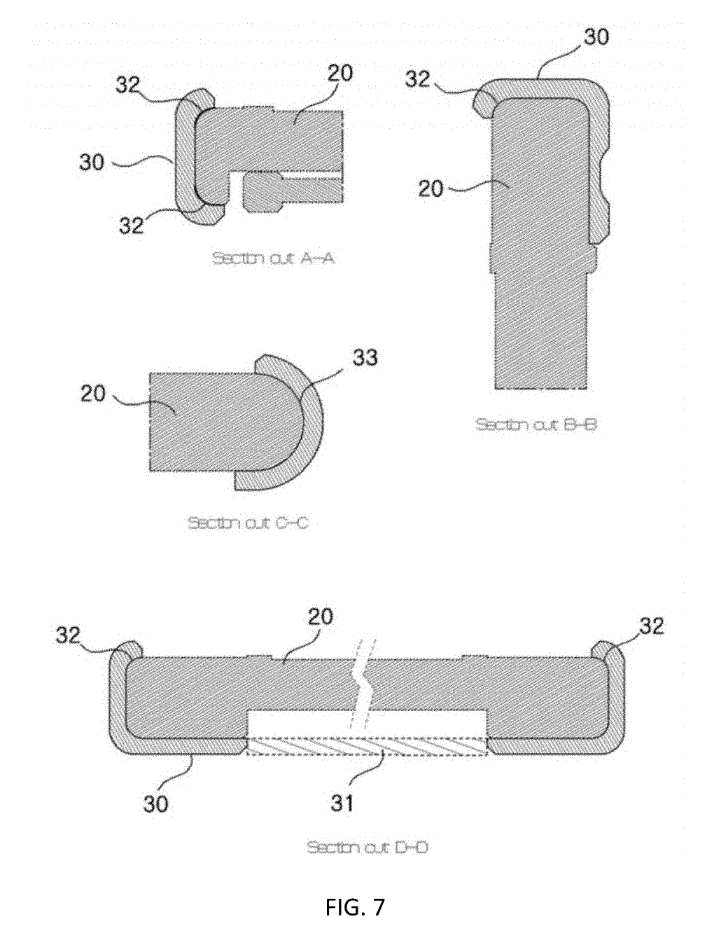

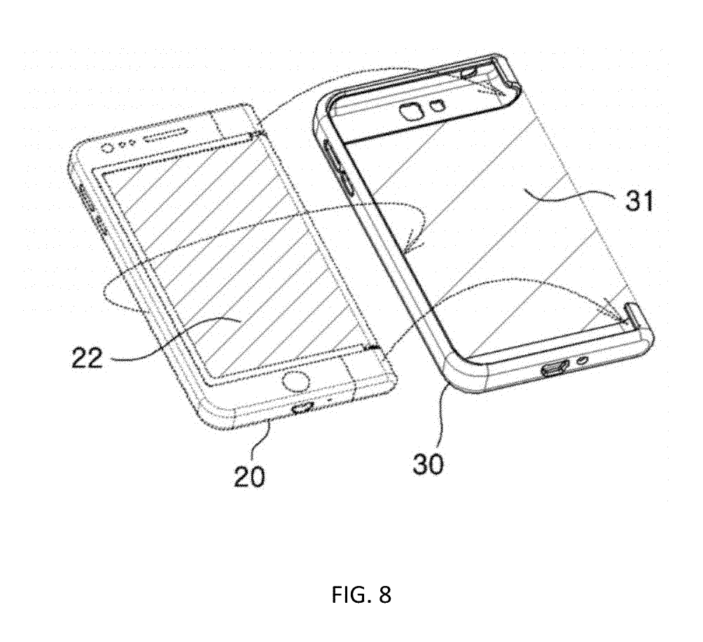

FIG. 6 is a plan view, a front view and a rear view showing an open-type bumper case applied to an asymmetric out-folding image display device of a folded state, FIG. 7 is cross-sectional views of the portions shown in FIG. 6, and FIG. 8 is a conceptual view of fixing an open-type bumper case to an asymmetric out-folding image display device.

An open-type bumper case 30, which is a first embodiment of the present invention, is applied to the circumference of an asymmetric out-folding image display device 20 and has an object of preventing damage by absorbing impacts through a bumper material applied to be fixed along the outer circumference when a user drops the asymmetric out-folding image display device 20 by mistake.

As shown in FIGS. 6, 7 and 8, the open-type bumper case 30 is applied to the asymmetric out-folding image display device 20. An interference removal area 31 part, which is an area included in the outer circumferential portion of the asymmetric out-folding image display device 20, where interference occurs when a folding axis is folded or unfolded, is formed open, and the open-type bumper case 30 is fixed while wrapping the circumferential portion of the other invariant area maintaining a constant shape and position at all times without being affected by folding or unfolding of the folding axis. To be stably latched and fixed to the asymmetric out-folding image display device 20 by itself without applying a separate fixing means, the open-type bumper case includes a corner latching step 32 formed at the portion contacting with a surface positioning on the opposite side of the folding axis of the asymmetric out-folding image display device 20 and at the portions contacting with the top circumference and the bottom circumference perpendicular to the folding axis of the out-folding image display device, and a folding axis part latching step 33 partially wrapping the other portions excluding the interference removal area 31 included in the portion positioning at the folding axis of the asymmetric out-folding image display device 20 is formed at the folding axis part.

In addition, a plurality of penetration holes for physical buttons, an earphone connection jack insertion hole, a rear camera, a speaker, a microphone and a USB connection terminal is preferably formed on the circumference and the rear surface of the open-type bumper case 30.

As shown in FIG. 8, the open-type bumper case 30 is fixed in a method of preferentially inserting and latching a surface positioning on the opposite side of the folding axis of the asymmetric out-folding image display device 20 to the corner latching steps 32 formed along the circumferential surface of the bumper case in which the interference removal area 31 is not formed and inserting and latching the circumference of the folding axis part of the asymmetric out-folding image display device 20 to the folding axis part latching step 33 parts formed on both sides facing the interference removal area 31 and spaced apart from each other.

Unlike the open-type bumper case 30 of the first embodiment applied while wrapping the outer circumference of an image display device, the main object of which is to prevent damage of the image display device through absorption of a dropping impact, application of a diary type case may be considered to protect an fixed screen display part 22 and a foldable and securable display 23 of the out-folding image display device from scratches or dents and provide a storage function on the inner side of the rotatable cover.

In order to apply the diary type case to an out-folding image display device as shown in FIGS. 2 and 3, the bottom surface fixing plate 15 should not be fixed to the out-folding image display device in a state incapable of rotating and should be maintained in a rotatable state.

In this case, since the fixing function of the bottom surface fixing plate 15 for fixing the diary type case to the out-folding image display device is removed, a different method should be separately prepared to fix the diary type case, and the method should also satisfy the condition of not generating interference to the unfolding and folding trajectory of the foldable and securable display 23 of the out-folding image display device. The present invention sequentially presents a fixing-support-plate applied case 40, a connection cover fixing case 41, an open-type bumper-integrated case 42 and a bottom cover partitioning case 43 as embodiments of fixing a diary type case to an out-folding image display device without generating interference, which makes rotation unable as the foldable and securable display 23 of the out-folding image display device is latched to the bottom surface fixing plate 15 when the folding axis of the out-folding image display device rotates, since the top surface cover plate 13 and the bottom surface fixing plate 15 may selectively rotate while maintaining the functions of a diary type case.

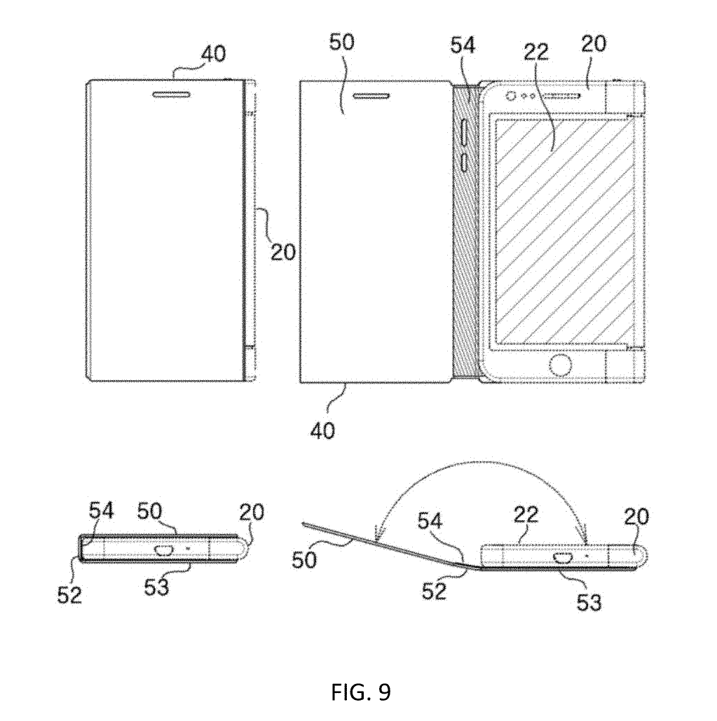

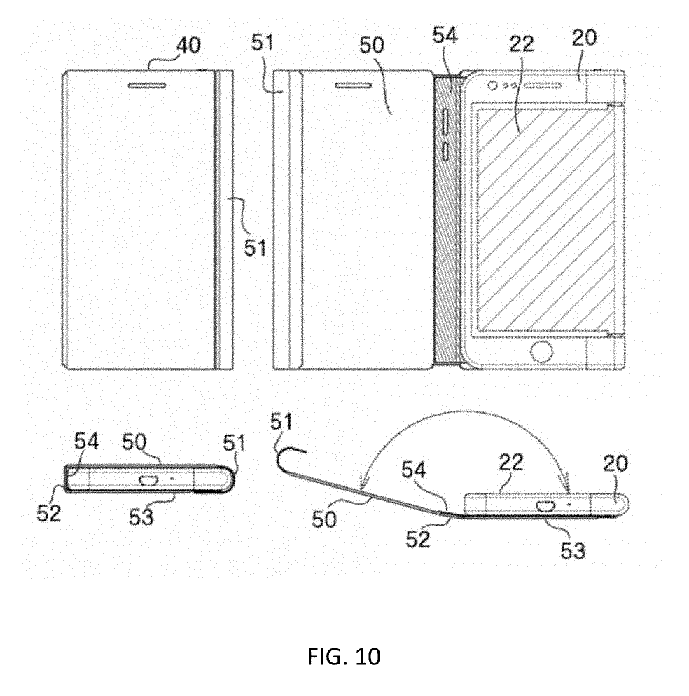

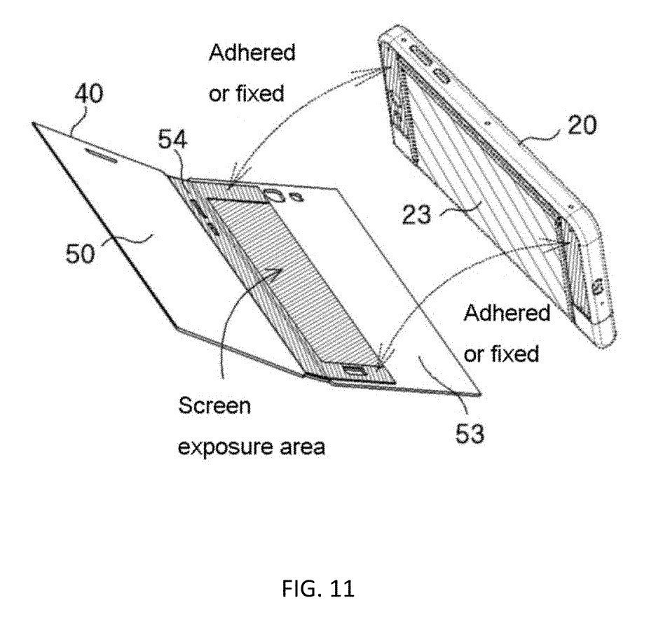

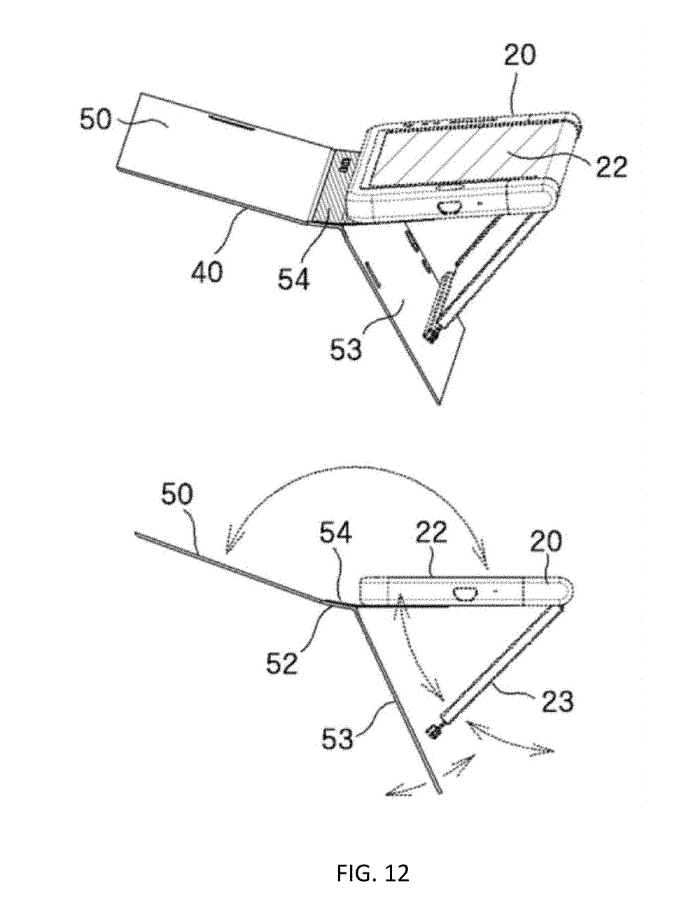

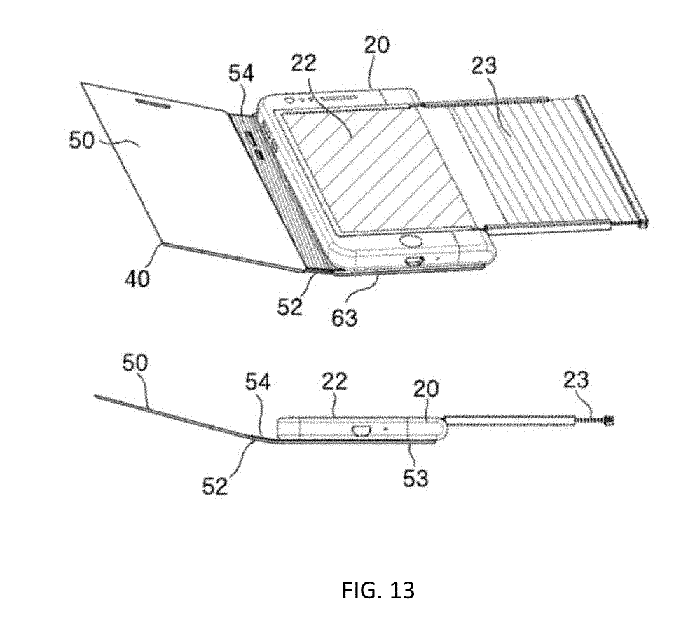

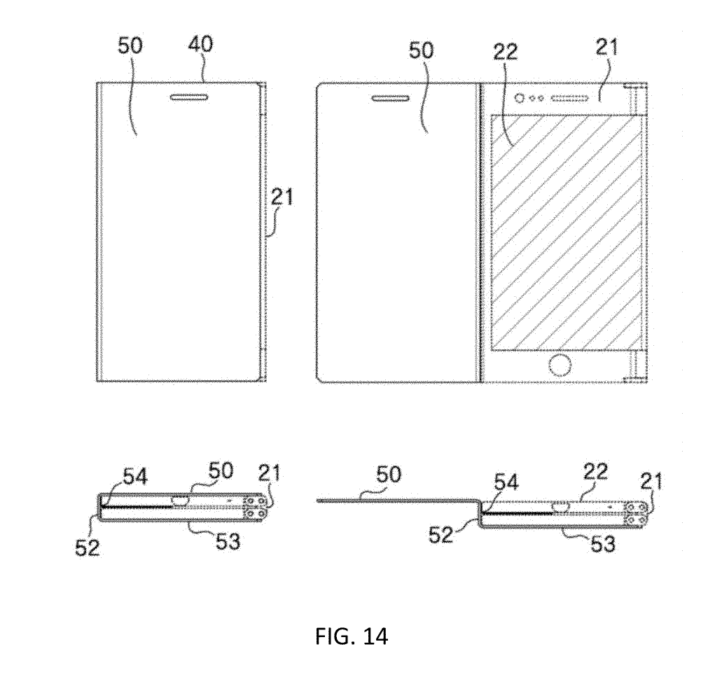

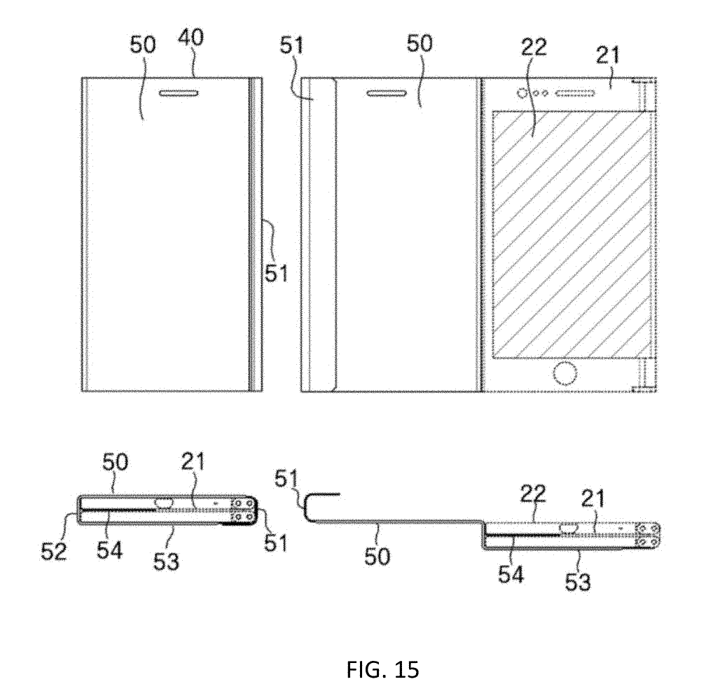

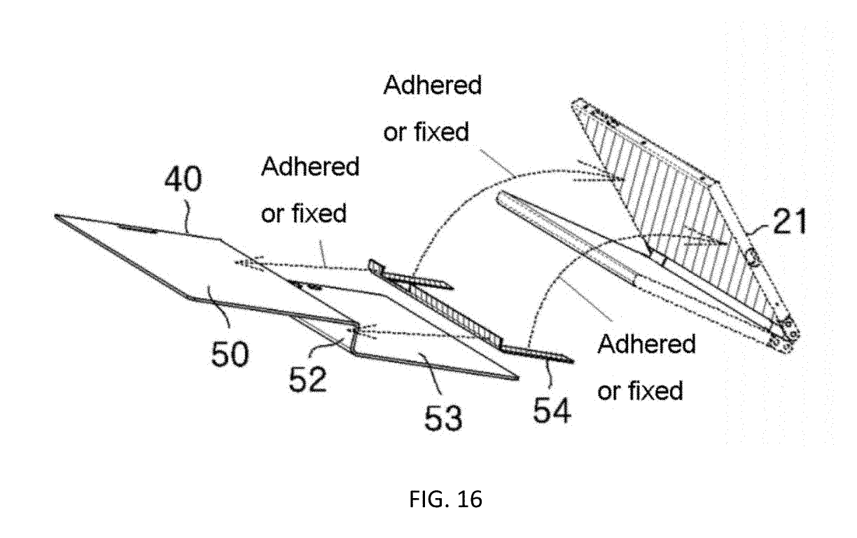

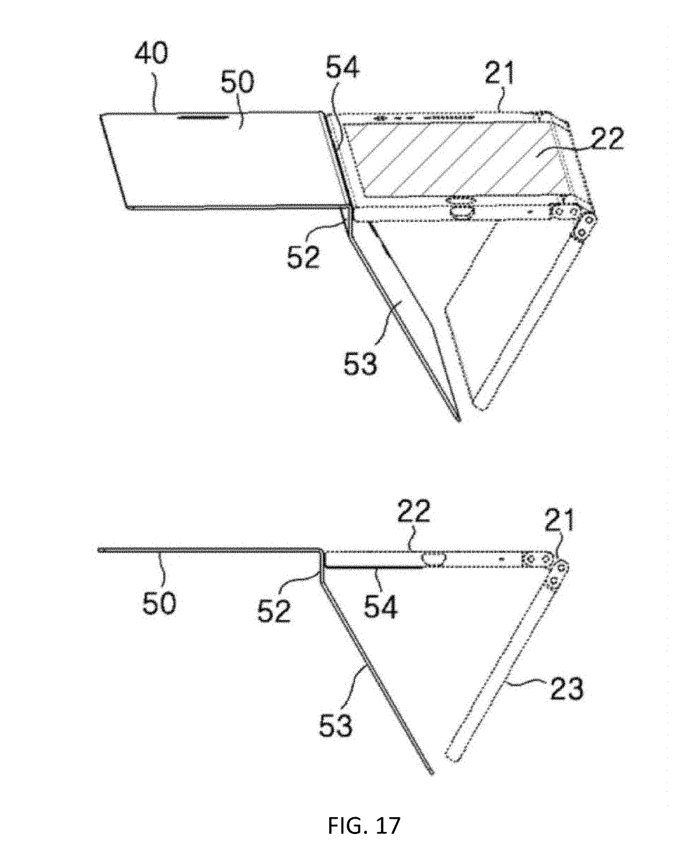

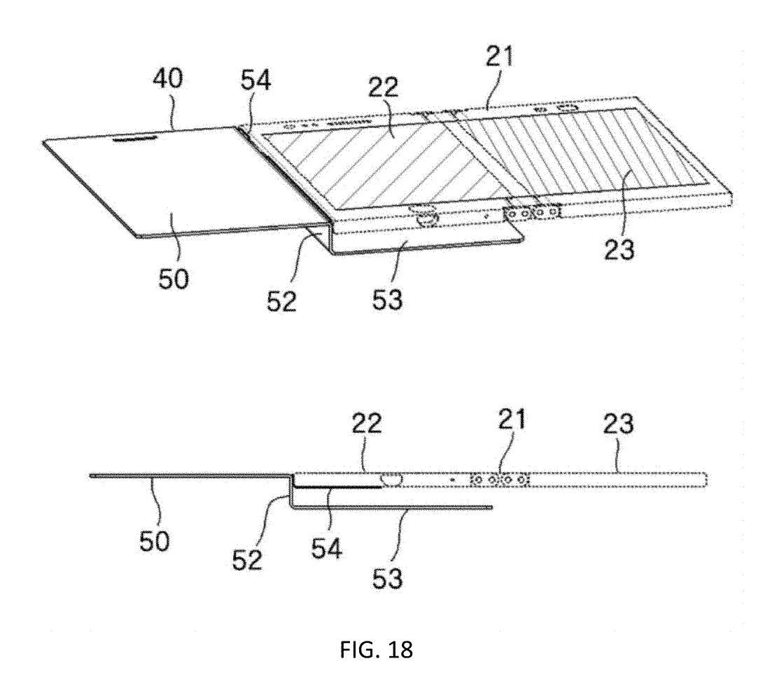

FIG. 9 is a plan view and a front view showing a fixing-support-plate applied case applied to an asymmetric out-folding image display device, FIG. 10 is a plan view and a front view showing a fixing-support-plate applied case provided with a folding axis cover and applied to an asymmetric out-folding image display device, FIG. 11 is a conceptual view of fixing a fixing-support-plate applied case to an asymmetric out-folding image display device, FIG. 12 is a perspective view and a front view showing a fixing-support-plate applied case applied to an asymmetric out-folding image display device and a folding and unfolding transition state, FIG. 13 is a perspective view and a front view showing a state of maintaining a completely spread state of a top open cover and a closed state of a bottom open cover while an asymmetric out-folding image display device applied with a fixing-support-plate applied case is in a completely spread state, FIG. 14 is a plan view and a front view showing a fixing-support-plate applied case applied to a symmetric out-folding image display device, FIG. 15 is a plan view and a front view showing a fixing-support-plate applied case provided with a folding axis cover and applied to a symmetric out-folding image display device, FIG. 16 is a conceptual view of fixing a fixing-support-plate applied case to a symmetric out-folding image display device, FIG. 17 is a perspective view and a front view showing a fixing-support-plate applied case applied to a symmetric out-folding image display device and a folding and unfolding transition state, and FIG. 18 is a perspective view and a front view showing a state of maintaining a completely spread state of a top open cover and a closed state of a bottom open cover while a symmetric out-folding image display device applied with a fixing-support-plate applied case is in a completely spread state.

FIGS. 9 to 13 show a second embodiment of applying a fixing-support-plate applied case 40 to the asymmetric out-folding image display device 20 and a third embodiment of applying a fixing-support-plate applied case 40 provided with a folding axis cover 51 to the asymmetric out-folding image display device 20, and FIGS. 14 to 18 show a fourth embodiment of applying a fixing-support-plate applied case 40 to the symmetric out-folding image display device 21 and a fifth embodiment of applying a fixing-support-plate applied case 40 provided with a folding axis cover 51 to the symmetric out-folding image display device 21.

As shown in FIGS. 9, 11, 12 and 13, the fixing-support-plate applied case 40 of the second embodiment configures a diary type case by including a top open cover 50 for selectively covering the fixed screen display part 22 of the asymmetric out-folding image display device 20 in a rotatable state and corresponding to the top surface fixing plate 13, a bottom open cover 53 for selectively covering the foldable and securable display 23 of the asymmetric out-folding image display device 20 in a rotatable state and corresponding to the bottom surface fixing plate 15, a connection cover 52 for connecting the top open cover 50 and the bottom open cover 53 and corresponding to the rotating connection plate 14 of the diary type case, and a fixing support plate 54, in which an end portion is adhered or fixed to a surface positioning on the opposite side of the fixed screen display part 22 of the asymmetric out-folding image display device 20, and the other unadhered or unfixed portions on the opposite side are adhered or fixed to a portion of the connection cover 52 or the connection cover 52 and the top open cover 50, and the fixing-support-plate applied case 40 is fixed to the asymmetric out-folding image display device 20 using the fixing support plate 54.

As shown in FIG. 11, in the second embodiment, penetration holes for handling physical buttons are formed at an end portion of the fixing support plate 54 corresponding to the connection cover 52 part, in which penetration holes related to a speaker and a camera may be formed at an end portion of the fixing support plate 54 corresponding to the bottom open cover 53 part, and a screen exposure area is formed open by removing a predetermined area so that the foldable and securable display 23 of the asymmetric out-folding image display device 20 may be exposed without being blocked.

As shown in FIG. 12, if the foldable and securable display 23 of the asymmetric out-folding image display device 20 stored in a folded state between the bottom open cover 53 and a surface on the opposite side of the fixed screen display part 22 of the asymmetric out-folding image display device 20 is switched to an unfolded state by folding axis rotation of the asymmetric out-folding image display device 20, a portion related to the foldable and securable display 23 departing from the surface on the opposite side of the fixed screen display part 22 of the asymmetric out-folding image display device 20 and rotating downwards rotates while rotating the bottom open cover 53 downwards in the opposite direction.

FIG. 13 shows a completely unfolded state of the foldable and securable display 23 of the asymmetric out-folding image display device 20 and a state of maintaining the bottom open cover 53, which has been rotated downwards in the opposite direction by downward rotation of the foldable and securable display 23, in a closed state by one-hand grip handling of the user.

If the folding axis of the asymmetric out-folding image display device 20 rotates toward the folded side to switch the foldable and securable display 23 of the asymmetric out-folding image display device 20 maintained in a completely unfolded state to a completely folded state, complete folding is not accomplished as the folded and rotated foldable and securable display 23 part is latched to the bottom open cover 53 maintained in a closed state, and in order to perform complete folding without being latched, the user should open the rotation section by partially rotating the bottom open cover 53 downwards so that the foldable and securable display 23 may not be latched.

As shown in FIG. 10, the third embodiment shows that the fixing-support-plate applied case 40 provided with a folding axis cover 51 may be applied to the asymmetric out-folding image display device 20. The fixing-support-plate applied case 40 of the second embodiment does not wrap the curved flexible display device portion existing between the fixed screen display part 22 and the foldable and securable display 23 of the asymmetric out-folding image display device 20, and therefore, it is always possible that the folding axis part can dented or scratched from the outside.

A method of wrapping the folding axis part should be applied to solve this problem, and the folding axis cover 51 part formed by extending a folding axis side end portion of the top open cover 50 or the bottom open cover 53 and wrapping the folding axis part is provided in the fixing-support-plate applied case 40, and FIG. 10 shows an embodiment of the folding axis cover 51 formed to be extended at a folding axis side end portion of the top open cover 50.

Since all the portions of the third embodiment are the same as those of the second embodiment excluding the folding axis cover 51 part, descriptions and drawings of related parts will be omitted.

The fixing-support-plate applied case 40 may be applied to the symmetric out-folding image display device 21 in a manner similar to the second embodiment of applying the fixing-support-plate applied case 40 to the asymmetric out-folding image display device 20, and this is shown in FIGS. 14, 16, 17 and 18 as a fourth embodiment.

As shown in FIGS. 14, 16, 17 and 18, the fixing-support-plate applied case 40 of the fourth embodiment configures a diary type case by including a top open cover 50 for selectively covering the fixed screen display part 22 of the symmetric out-folding image display device 21 in a rotatable state and corresponding to the top surface fixing plate 13, a bottom open cover 53 for selectively covering the foldable and securable display 23 of the symmetric out-folding image display device 21 in a rotatable state and corresponding to the bottom surface fixing plate 15, a connection cover 52 for connecting the top open cover 50 and the bottom open cover 53 and corresponding to the rotating connection plate 14 of the diary type case, and a fixing support plate 54, in which an end portion is adhered or fixed on a surface on the opposite side of the fixed screen display part 22 of the symmetric out-folding image display device 21, not a surface on the opposite side of the foldable and securable display 23 of the symmetric out-folding image display device 21, and the other unadhered or unfixed portions on the opposite side are adhered or fixed to a portion of the connection cover 52 or the connection cover 52 and the top open cover 50, and the fixing-support-plate applied case 40 is fixed to the symmetric out-folding image display device 21 using the fixing support plate 54.

Comparing the fourth embodiment and the second embodiment, since the out-folding image display device and the adhered or fixed position of the fixing support plate 54 adhered or fixed to the out-folding image display device are different and the others are the same, FIGS. 14, 16, 17 and 18 will not be described separately.

In addition, as shown in FIG. 15, the fifth embodiment shows that the fixing-support-plate applied case 40 provided with a folding axis cover 51 may be applied to the symmetric out-folding image display device 21.

The folding axis cover 51 part is formed by extending a folding axis side end portion of the top open cover 50 or the bottom open cover 53 and applied to the fixing-support-plate applied case 40 to wrap the folding axis part, and FIG. 15 shows an embodiment of the folding axis cover 51 formed to be extended at the folding axis side end portion of the top open cover 50.

Comparing the fifth embodiment to the fourth embodiment, since whether or not to apply the folding axis cover 51 is different and the others are the same, FIG. 15 will not be described separately.

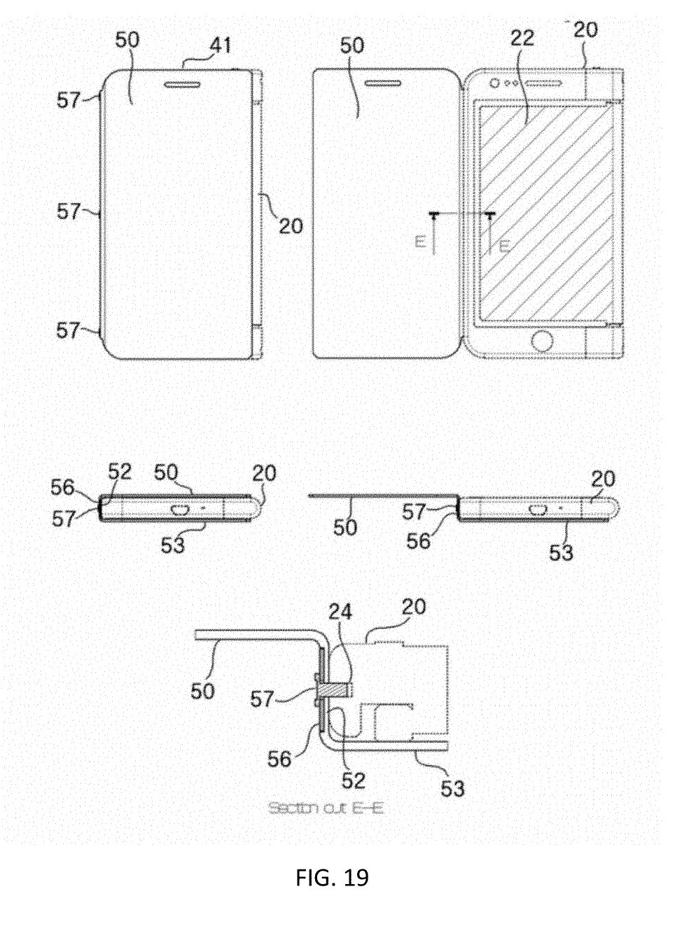

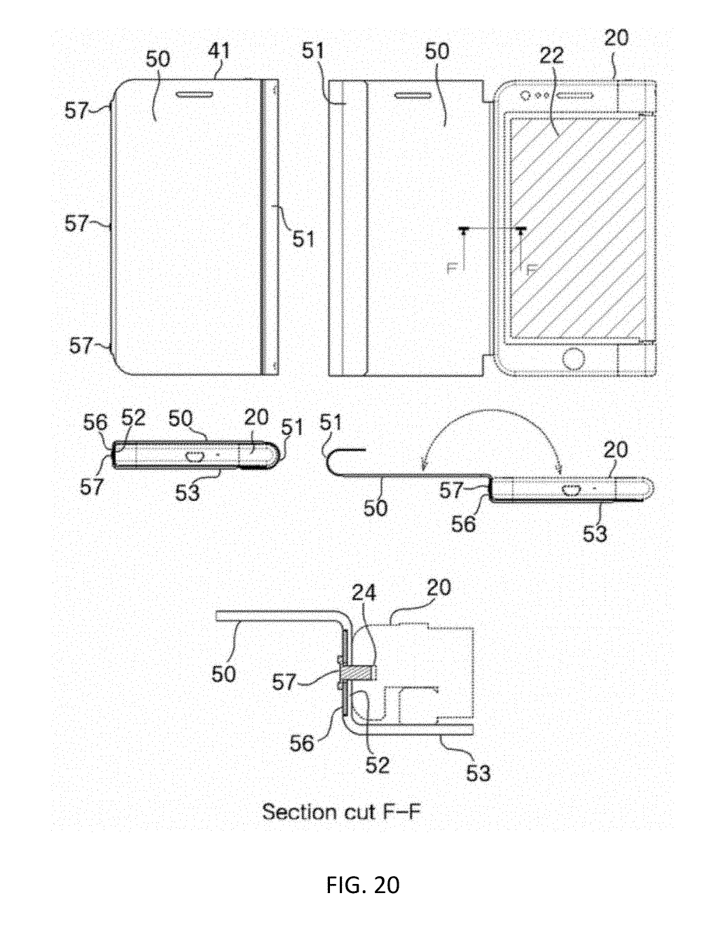

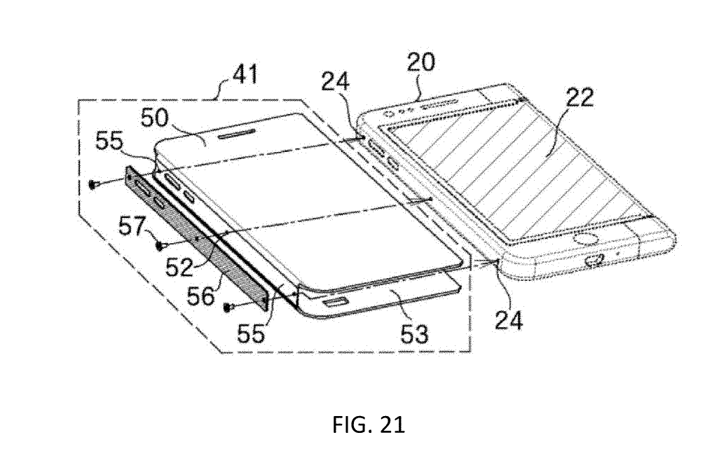

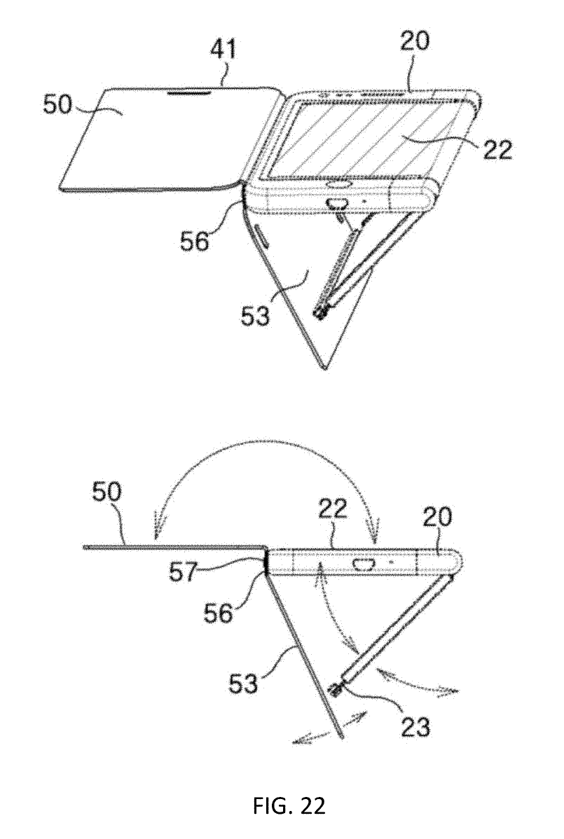

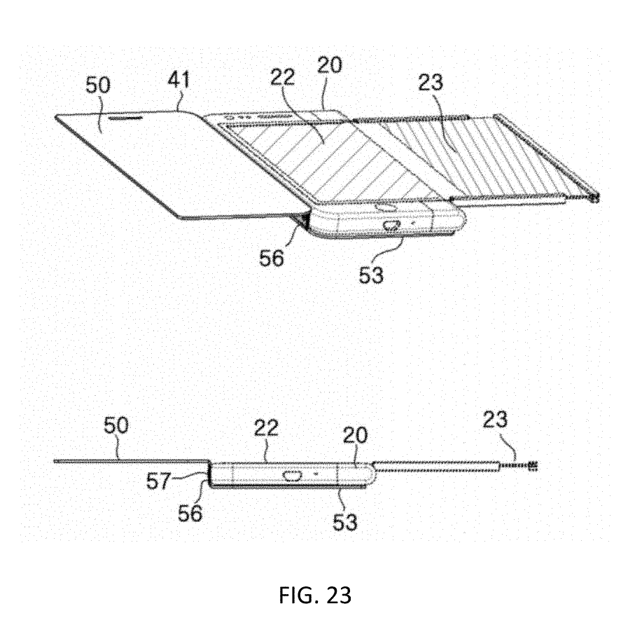

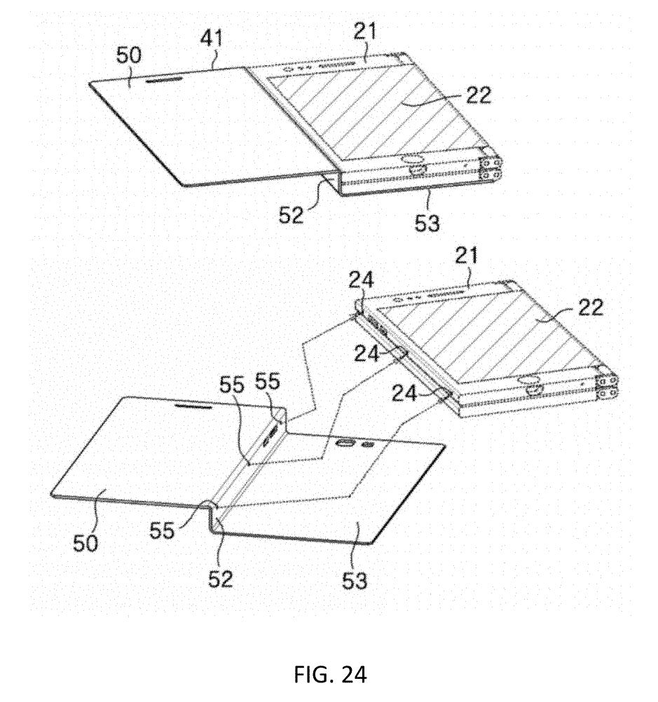

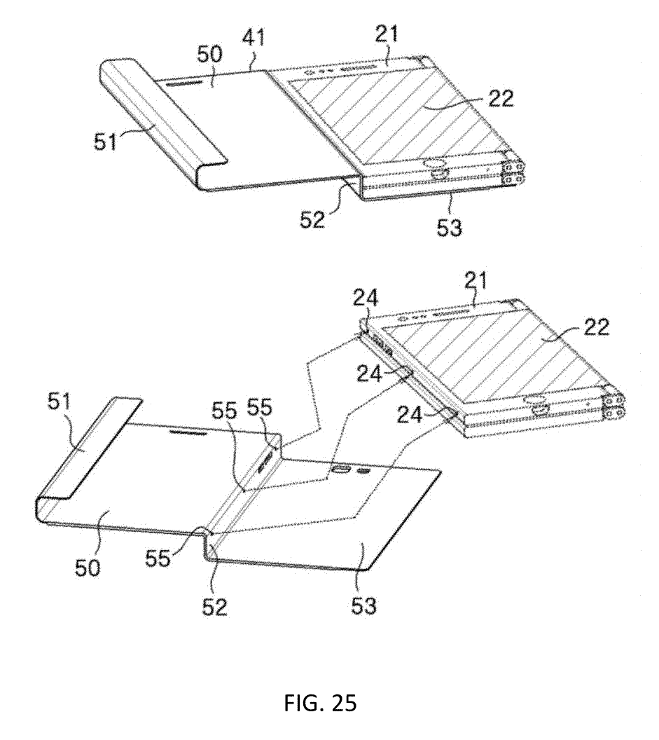

FIG. 19 is a plan view, a front view and a cross-sectional view showing a connection cover fixing case applied to an asymmetric out-folding image display device, FIG. 20 is a plan view and a front view showing a connection cover fixing case provided with a folding axis cover and applied to an asymmetric out-folding image display device, FIG. 21 is a conceptual view of fixing a connection cover fixing case to an asymmetric out-folding image display device, FIG. 22 is a perspective view and a front view showing a folding and unfolding transition state of an asymmetric out-folding image display device applied with a connection cover fixing case, FIG. 23 is a perspective view and a front view showing a state of maintaining a completely spread state of a top open cover and a closed state of a bottom open cover while an asymmetric out-folding image display device applied with a connection cover fixing case is in a completely spread state, FIG. 24 is a perspective view and a conceptual view showing a connection cover fixing case applied and fixed to a symmetric out-folding image display device, and FIG. 25 is a perspective view and a conceptual view showing a connection cover fixing case provided with a folding axis cover and applied and fixed to a symmetric out-folding image display device.

FIGS. 19 to 23 show a sixth embodiment of applying a connection cover fixing case 41 to the asymmetric out-folding image display device 20 and a seventh embodiment of applying a connection cover fixing case 41 provided with a folding axis cover 51 to the asymmetric out-folding image display device 20, and FIGS. 24 and 25 show an eighth embodiment of applying a connection cover fixing case 41 to the symmetric out-folding image display device 21 and a ninth embodiment of applying a connection cover fixing case 41 provided with a folding axis cover 51 to the symmetric out-folding image display device 21.

As shown in FIGS. 19, 21, 22 and 23, the connection cover fixing case 41 of the sixth embodiment is configured to include a top open cover 50 for selectively covering the fixed screen display part 22 of the asymmetric out-folding image display device 20 in a rotatable state and corresponding to the top surface fixing plate 13, a bottom open cover 53 for selectively covering the foldable and securable display 23 of the asymmetric out-folding image display device 20 in a rotatable state and corresponding to the bottom surface fixing plate 15, a connection cover 52 for connecting the top open cover 50 and the bottom open cover 53, having one or more penetration holes 55 penetratingly formed to be fixed to one or more protective case fixing holes 24 formed on a surface on the opposite side of the folding axis of the asymmetric out-folding image display device 20 and corresponding to the rotating connection plate 14 of the diary type case, and a load distribution plate 56 fixed to the protective case fixing holes 24 of the asymmetric out-folding image display device 20 using a fixing means including a fixing screw 57 to press the connection cover 52 to be fixed on a surface on the opposite side of the folding axis of the asymmetric out-folding image display device 20, and the connection cover fixing case 41 is fixed to the asymmetric out-folding image display device 20 having one or more protective case fixing holes 24 formed on a surface on the opposite side of the folding axis using the fixing screws 57 and the load distribution plate 56. As shown in FIG. 21, in the sixth embodiment, penetration holes for handling physical buttons are formed in the connection cover 52 part, and penetration holes corresponding to the physical buttons are also formed in the load distribution plate pressing the connection cover 52 from the outside of the connection cover 52 to be fixed to the asymmetric out-folding image display device 20.

In addition, as shown in the cross-sectional views of FIGS. 19 and 20, the load distribution plate 56 is assembled to be recessed so that the circumference portion may not be protruded toward the outside of the connection cover 52 not to give a feeling of being latched to a user's hand, and the central portion is protruded in a halfmoon shape, not a plate shape, so that the head portion of the fixing screw 57 may not be protruded, and the head portion of the fixing screw 57 may be maintained in a state recessed toward the inside of the protruded portion.

As shown in FIG. 22, if the foldable and securable display 23 of the asymmetric out-folding image display device 20 stored in a folded state between the bottom open cover 53 and a surface on the opposite side of the fixed screen display part 22 of the asymmetric out-folding image display device 20 is switched to an unfolded state by folding axis rotation of the asymmetric out-folding image display device 20, a portion related to the foldable and securable display 23 departing from the surface on the opposite side of the fixed screen display part 22 of the asymmetric out-folding image display device 20 and rotating downwards rotates while rotating the bottom open cover 53 downwards in the opposite direction.

FIG. 23 shows a completely unfolded state of the foldable and securable display 23 of the asymmetric out-folding image display device 20 and a state of maintaining the bottom open cover 53, which has been rotated downwards in the opposite direction by downward rotation of the foldable and securable display 23, in a closed state by one-hand grip handling of the user.

If the folding axis of the asymmetric out-folding image display device 20 is rotated toward the folded side in order to switch the foldable and securable display 23 of the asymmetric out-folding image display device 20 maintained in a completely unfolded state to a completely folded state, complete folding is not accomplished as the foldable and securable display 23 part folded and rotated is latched to the bottom open cover 53 maintained in a closed state, and in order to perform complete folding without being latched, the user should open the rotation section by partially rotating the bottom open cover 53 downwards so that the foldable and securable display 23 may not be latched.

As shown in FIG. 20, the seventh embodiment shows that the connection cover fixing case 41 provided with a folding axis cover 51 may be applied to the asymmetric out-folding image display device 20. Like the third embodiment, the folding axis cover 51 part formed by extending a folding axis side end portion of the top open cover 50 or the bottom open cover 53 of the seventh embodiment and wrapping the folding axis part is provided in the connection cover fixing case 41, and FIG. 20 shows an embodiment of the folding axis cover 51 formed to be extended at a folding axis side end portion of the top open cover 50.

Since all the portions of the seventh embodiment are the same as those of the sixth embodiment excluding the folding axis cover 51 part, descriptions and drawings of related parts will be omitted.

The connection cover fixing case 41 may be applied to the symmetric out-folding image display device 21 in a manner similar to the sixth embodiment of applying the connection cover fixing case 41 to the asymmetric out-folding image display device 20, and this is shown in FIG. 24 as an eighth embodiment.

As shown in FIG. 24, the connection cover fixing case 41 of the eighth embodiment is configured to include a top open cover 50 for selectively covering the fixed screen display part 22 of the symmetric out-folding image display device 21 in a rotatable state and corresponding to the top surface fixing plate 13, a bottom open cover 53 for selectively covering the foldable and securable display 23 of the symmetric out-folding image display device 21 in a rotatable state and corresponding to the bottom surface fixing plate 15, a connection cover 52 for connecting the top open cover 50 and the bottom open cover 53, having one or more penetration holes 55 penetratingly formed to be fixed to one or more protective case fixing holes 24 formed on a surface on the opposite side of the folding axis of the symmetric out-folding image display device 21 and corresponding to the rotating connection plate 14 of the diary type case, and a load distribution plate 56 fixed to the protective case fixing holes 24 of the symmetric out-folding image display device 21 using a fixing means including a fixing screw 57 to press the connection cover 52 to be fixed on a surface on the opposite side of the folding axis of the symmetric out-folding image display device 21, and the connection cover fixing case 41 is fixed to the symmetric out-folding image display device 21 having one or more protective case fixing holes 24 formed on a surface on the opposite side of the folding axis using the fixing screws 57 and the load distribution plate 56.

Comparing the eighth embodiment and the sixth embodiment, since the opposite side of the folding axis of an out-folding image display device having one or more protective case fixing holes 24 formed thereon is different and the others are the same, FIG. 24 will not be described separately. In addition, as shown in FIG. 25, the ninth embodiment shows that the connection cover fixing case 41 provided with a folding axis cover 51 may be applied to the symmetric out-folding image display device 21.

The folding axis cover 51 part is formed by extending a folding axis side end portion of the top open cover 50 or the bottom open cover 53 and applied to the fixing-support-plate applied case 40 to wrap the folding axis part, and FIG. 15 shows an embodiment of the folding axis cover 51 formed to be extended at the folding axis side end portion of the top open cover 50.

Comparing the ninth embodiment and the eighth embodiment, since whether or not to apply the folding axis cover 51 is different and the others are the same, FIG. 25 will not be described separately.

As shown in FIG. 22, if the foldable and securable display 23 of the asymmetric out-folding image display device 20 stored in a folded state between the bottom open cover 53 and a surface on the opposite side of the fixed screen display part 22 of the asymmetric out-folding image display device 20 is switched to an unfolded state by folding axis rotation of the asymmetric out-folding image display device 20, a portion related to the foldable and securable display 23 departing from the surface on the opposite side of the fixed screen display part 22 of the asymmetric out-folding image display device 20 and rotating downwards rotates while rotating the bottom open cover 53 downwards in the opposite direction.

FIG. 23 shows a completely unfolded state of the foldable and securable display 23 of the asymmetric out-folding image display device 20 and a state of maintaining the bottom open cover 53, which has been rotated downwards in the opposite direction by downward rotation of the foldable and securable display 23, in a closed state by one-hand grip handling of the user.

If the folding axis of the asymmetric out-folding image display device 20 is rotated toward the folded side in order to switch the foldable and securable display 23 of the asymmetric out-folding image display device 20 maintained in a completely unfolded state to a completely folded state, complete folding is not accomplished as the foldable and securable display 23 part folded and rotated is latched to the bottom open cover 53 maintained in a closed state, and in order to perform complete folding without being latched, the user should open the rotation section by partially rotating the bottom open cover 53 downwards so that the foldable and securable display 23 may not be latched.

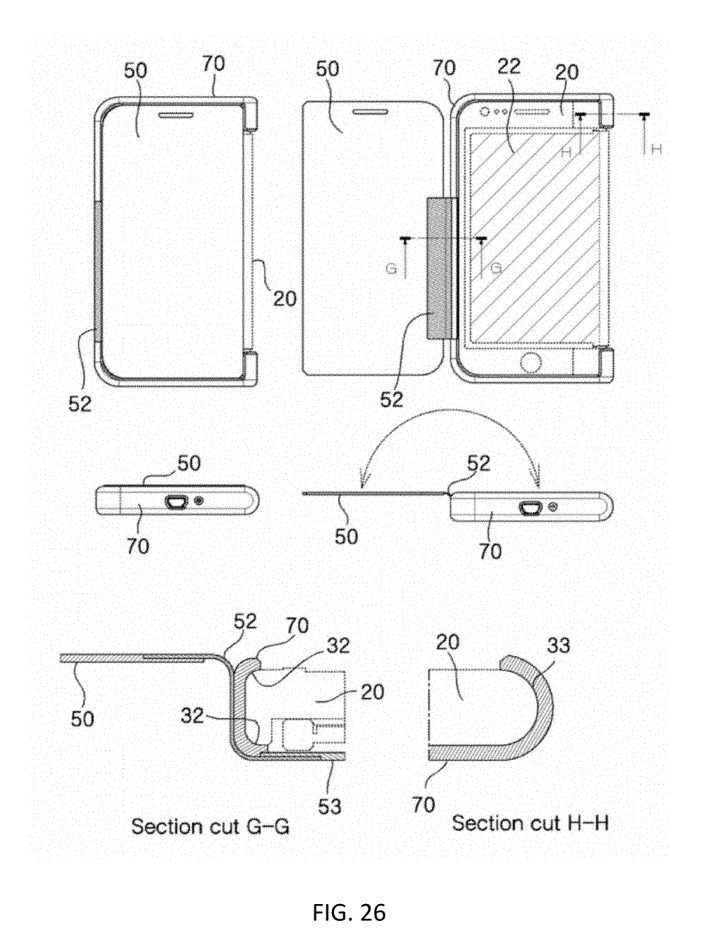

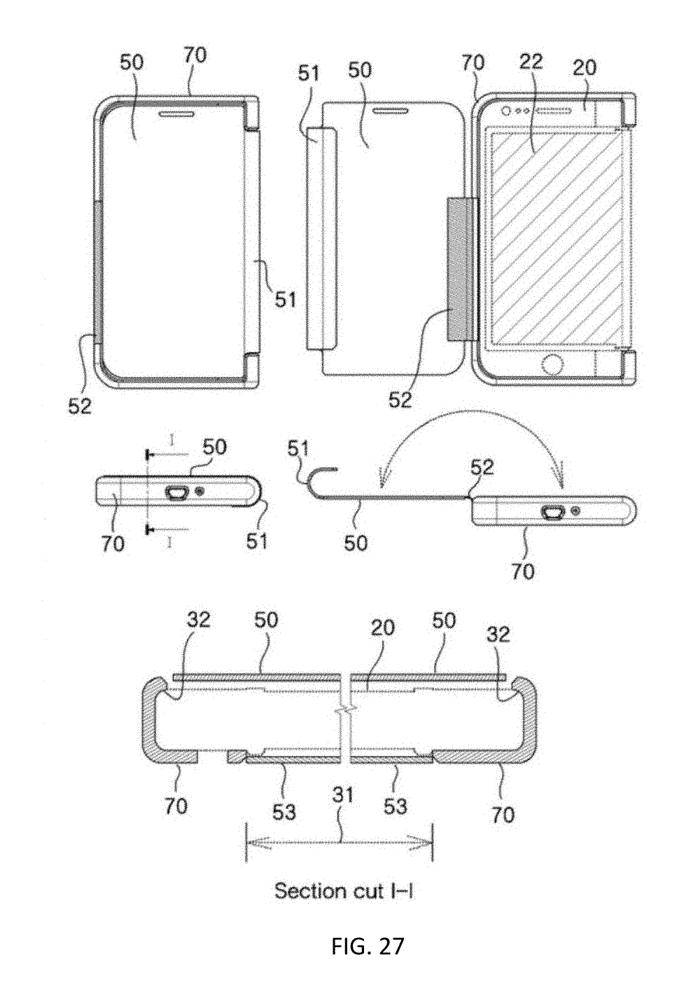

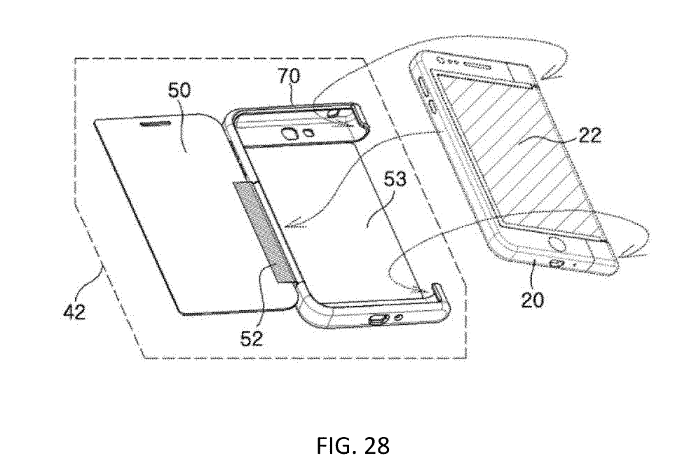

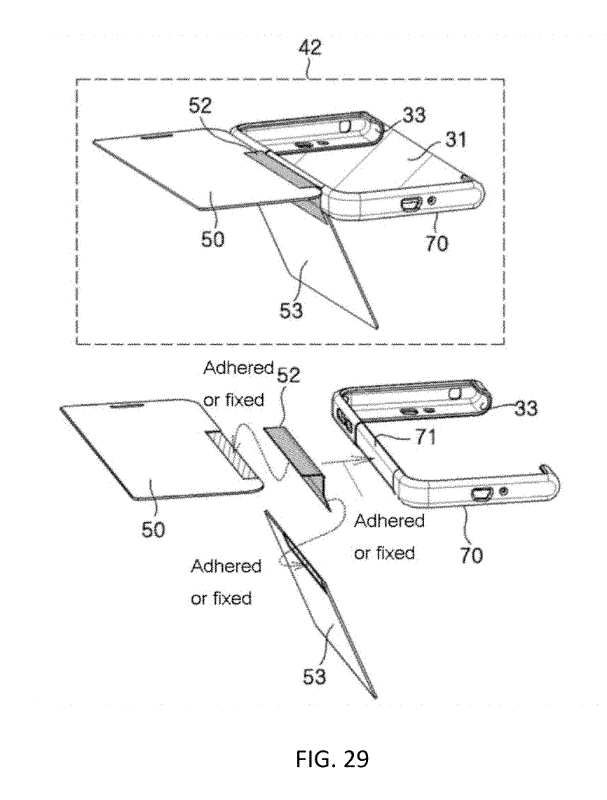

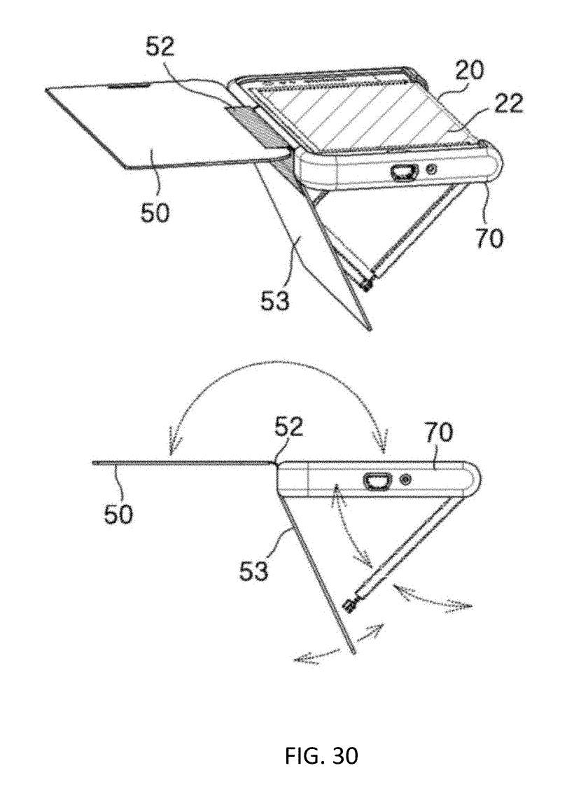

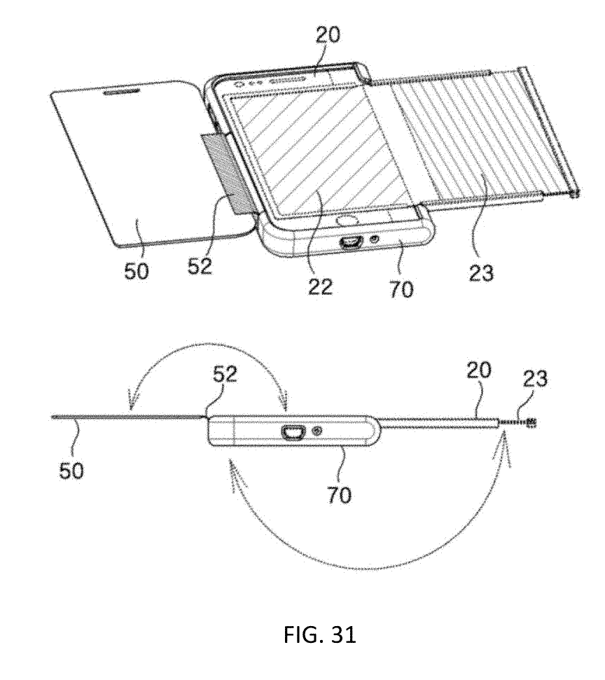

FIG. 26 is a plan view, a front view and a cross-sectional view showing an open-type bumper-integrated case applied to an asymmetric out-folding image display device, FIG. 27 is a plan view, a front view and a cross-sectional view showing an open-type bumper-integrated case provided with a folding axis cover and applied to an asymmetric out-folding image display device, FIG. 28 is a conceptual view of fixing an open-type bumper-integrated case to an asymmetric out-folding image display device, FIG. 29 is a perspective view and an exploded perspective view showing an open-type bumper-integrated case, FIG. 30 is a perspective view and a front view showing a folding and unfolding transition state of an asymmetric out-folding image display device applied with an open-type bumper-integrated case, and FIG. 31 is a perspective view and a front view showing a state of maintaining a completely spread state of a top open cover and a closed state of a bottom open cover while an asymmetric out-folding image display device applied with an open-type bumper-integrated case is in a completely spread state.

FIGS. 26 to 31 show a tenth embodiment of applying an open-type bumper-integrated case 42 to the asymmetric out-folding image display device 20 and an eleventh embodiment of applying an open-type bumper-integrated case 42 provided with a folding axis cover 51 to the asymmetric out-folding image display device 20.

As shown in FIGS. 26, 28, 29, 30 and 31, the open-type bumper-integrated case 42 of the tenth embodiment is configured to include a top open cover 50 for selectively covering the fixed screen display part 22 of the asymmetric out-folding image display device 20 in a rotatable state and corresponding to the top surface fixing plate 13, a bottom open cover 53 for selectively covering the foldable and securable display 23 of the asymmetric out-folding image display device 20 in a rotatable state and corresponding to the bottom surface fixing plate 15, an open-type bumper 70 applied to be latched to the shape-invariant circumference of the asymmetric out-folding image display device 20 and formed open by removing the interference removal area 31 part, which is an area included in the outer circumferential portion of the asymmetric out-folding image display device 20, where interference occurs when a folding axis is folded or unfolded, in which one surfaces of the fixed screen display part 22 and the foldable and securable display 23 side have an open shape, and a connection cover 52 for connecting the top open cover 50 and the bottom open cover 53, in which a corresponding portion is adhesively or connectedly fixed to a connection cover recess fixing unit 71 formed on a surface positioning on the opposite side of the folding axis of the asymmetric out-folding image display device 20 among the one surfaces of the open-type bumper 70.

As shown in FIGS. 28 and 29, in the tenth embodiment, the central portion of the connection cover 52 formed on the circumference of the open-type bumper 70 is adhesively or connectedly fixed to the connection cover recess fixing unit 71 formed in the open-type bumper 70, and both end portions are adhesively or connectedly fixed to the folding axis side end portions of the top open cover 50 and the bottom open cover 53. Through the configuration, the bottom open cover 53 may selectively rotate to cover and protect the foldable and securable display 23 of the asymmetric out-folding image display device 20.

A bottom open cover 53 without a folding axis cover 51 may have a vertical width parallel to the folding axis direction and the same as that of a top open cover 50 without a folding axis cover 51 or may have a width as wide as to cover only the interference removal area 31 as shown in the cross-sectional view of FIG. 27.

Since the open-type bumper 70 of the tenth embodiment as shown in FIG. 26 is the same as the open-type bumper case 30 of the first embodiment except that the connection cover recess fixing unit 71 is not formed, details thereof will be omitted.

In addition, as shown in FIG. 27, the eleventh embodiment shows that the open-type bumper-integrated case 42 provided with a folding axis cover 51 may be applied to the asymmetric out-folding image display device 20.

The folding axis cover 51 part is formed by extending a folding axis side end portion of the top open cover 50 or the bottom open cover 53 and applied to the fixing-support-plate applied case 40 to wrap the folding axis part, and FIG. 27 shows an embodiment of the folding axis cover 51 formed to be extended at the folding axis side end portion of the top open cover 50.

Comparing the eleventh embodiment and the tenth embodiment, since whether or not to apply the folding axis cover 51 is different and the others are the same, FIG. 27 will not be described separately.

As shown in FIG. 30, if the foldable and securable display 23 of the asymmetric out-folding image display device 20 stored in a folded state between the bottom open cover 53 and a surface on the opposite side of the fixed screen display part 22 of the asymmetric out-folding image display device 20 is switched to an unfolded state by folding axis rotation of the asymmetric out-folding image display device 20, a portion related to the foldable and securable display 23 departing from the surface on the opposite side of the fixed screen display part 22 of the asymmetric out-folding image display device 20 and rotating downwards rotates while rotating the bottom open cover 53 downwards in the opposite direction.

FIG. 31 shows a completely unfolded state of the foldable and securable display 23 of the asymmetric out-folding image display device 20 and a state of maintaining the bottom open cover 53, which has been rotated downwards in the opposite direction by downward rotation of the foldable and securable display 23, in a closed state by one-hand grip handling of the user.

If the folding axis of the asymmetric out-folding image display device 20 is rotated toward the folded side in order to switch the foldable and securable display 23 of the asymmetric out-folding image display device 20 maintained in a completely unfolded state to a completely folded state, complete folding is not accomplished as the foldable and securable display 23 part folded and rotated is latched to the bottom open cover 53 maintained in a closed state, and in order to perform complete folding without being latched, the user should open the rotation section by partially rotating the bottom open cover 53 downwards so that the foldable and securable display 23 may not be latched.

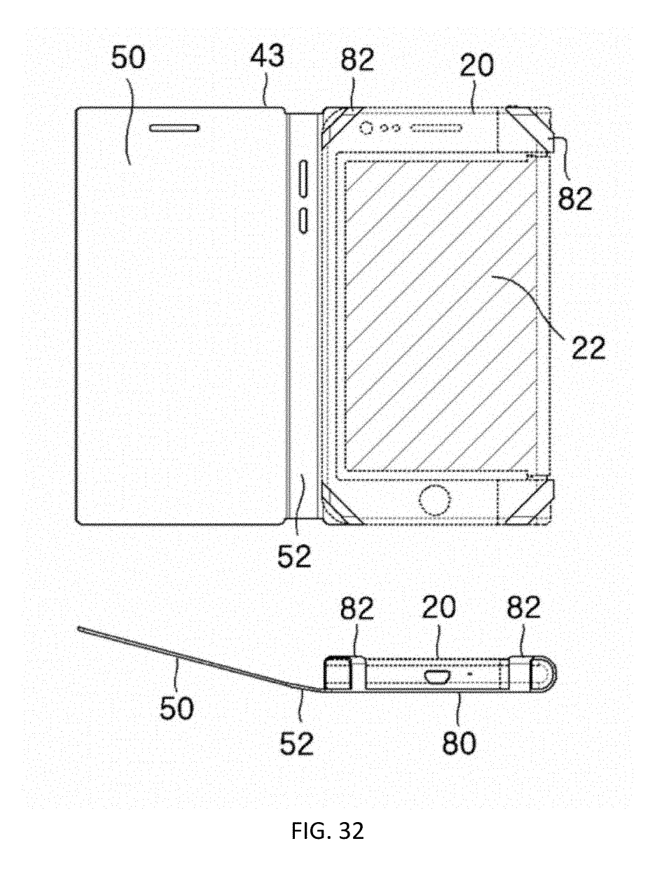

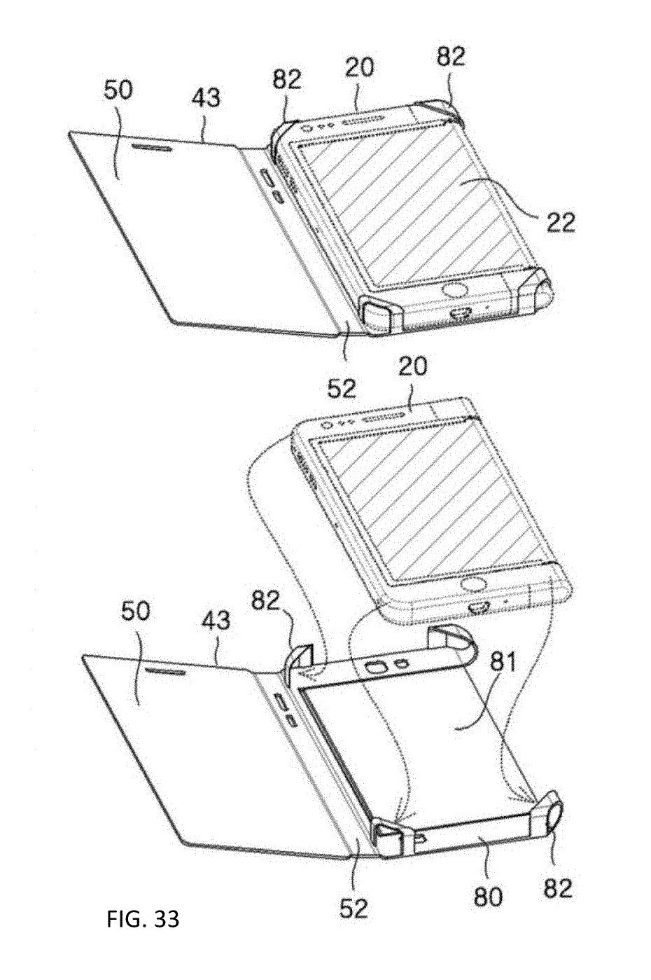

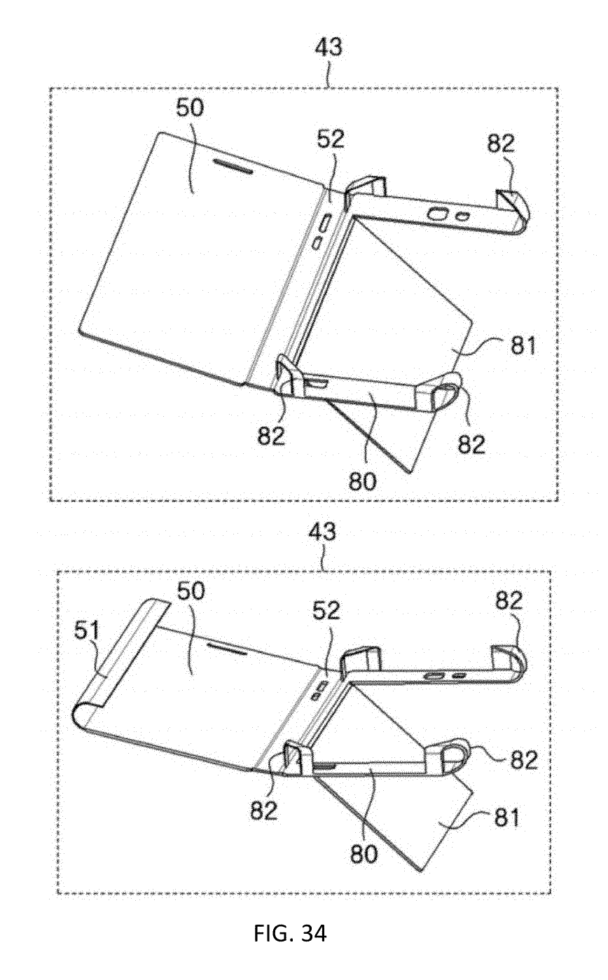

FIG. 32 is a plan view and a front view showing a bottom cover partitioning case applied to an asymmetric out-folding image display device, FIG. 33 is a perspective view and a conceptual view showing a bottom cover partitioning case applied and fixed to an asymmetric out-folding image display device, and FIG. 34 is perspective views of a bottom cover partitioning case not applied with a folding axis cover and a bottom cover partitioning case applied with a folding axis cover, which are applied to an asymmetric out-folding image display device.

FIGS. 32 and 33 show a twelfth embodiment of applying a bottom cover partitioning case 43 to the asymmetric out-folding image display device 20 and a thirteenth embodiment of applying a bottom cover partitioning case 43 provided with a folding axis cover 51 to the asymmetric out-folding image display device 20. As shown in FIGS. 32 and 33, the bottom cover partitioning case 43 of the twelfth embodiment is configured to include a top open cover 50 for selectively covering the fixed screen display part 22 of the asymmetric out-folding image display device 20 in a rotatable state and corresponding to the top surface fixing plate 13, a bottom partition fixing cover 80 fixed to the asymmetric out-folding image display device 20 in a state incapable of rotating as the portions on one surface positioned when the foldable and securable display 23 of the asymmetric out-folding image display device 20 is in a folded state, excluding the interference removal area 31 part related to rotation of the foldable and securable display 23, are latched and fixed to a plurality of fixing bands and corresponding to the bottom surface fixing plate 15, a bottom rotating cover 81 separated while an end portion is connected to the bottom partition fixing cover 80 in a rotatable state at a portion positioning in the interference removal area 31 of the bottom partition fixing cover 80 in a selectively rotatable state, or fixed in a rotatable state by the separately applied connection cover 52, and the connection cover 52 for connecting the top open cover 50 and the bottom partition fixing cover 80 and corresponding to the rotating connection plate 14 of the diary type case.

As shown in FIGS. 33 and 34, in the twelfth embodiment, the asymmetric out-folding image display device 20 is fixed as the corner portions are latched to the fixing bands 82 provided at the corners of the bottom partition fixing cover 80, and since the bottom rotating cover 81 maintains a selectively rotatable state although the bottom partition fixing cover 80 is fixed, the foldable and securable display 23 may rotate by folding axis rotation of the asymmetric out-folding image display device 20 without being latched.

While the embodiments of the present invention have been described with reference to the accompanying drawings, it will be understood by those skilled in the art that the present invention may be embodied in other specific forms without departing from the spirit and essential characteristics thereof. The present embodiments described above are therefore to be considered in all respects as illustrative and not restrictive.

1-25. (canceled)

26. A case of an out-folding image display device having a folding axis formed at one side of the image display device, and a flexible image display device configured of: a fixed screen display part fixed on a front surface of the image display device, and a foldable and securable display part that can be folded or unfolded around the folding axis, wherein a length of one side of the foldable and securable display part in one direction does not accord with a length of the out-folding image display device in the same direction,
the case comprising an open-type bumper for wrapping a circumference of the out-folding image display device,
wherein an interference removal area is formed as an opening by cutting off a portion corresponding to an outer side of the folding axis of the open-type bumper.

27. The case according to claim 26, wherein corner latching steps for fixing the image display device inside the open-type bumper by contacting with corners of the image display device are formed on an inner surface on an opposite side of the folding axis of the open-type bumper and on both inner surfaces perpendicular to the folding axis.

28. The case according to claim 26, wherein folding axis portion latching steps for fixing the image display device inside the open-type bumper by contacting with corners of the image display device are formed in other areas excluding the interference removal area, as an inner surface of the open-type bumper in a folding axis direction.
